(19) United States
(12) Patent Application Publication
(10) Pub. No.: US 2020/0339738 A1
(43) Pub. Date: Oct. 29, 2020

(54) HOT MELT EPOXY RESIN SYSTEM AND PROCESS FOR MAKING THE SAME

(71) Applicant: KORDSA TEKNIK TEKSTIL A.S., Kocaeli (TR)

(72) Inventors: Cem OZTURK, Kocaeli (TR); Deniz KORKMAZ, Kocaeli (TR)

(73) Assignee: KORDSA TEKNIK TEKSTIL A.S., Kocaeli (TR)

(21) Appl. No.: 16/958,754

(22) PCT Filed: Dec. 14, 2018
(86) PCT No.: PCT/TR2018/050808

§ 371 Date: Jun. 29, 2020

(30) Foreign Application Priority Data
Dec. 29, 2017 (TR) 2017/22994

(51) Int. Cl. C08G 59/44; C08K 3/36; C08L 63/04; C08K 5/07; C08K 5/17; C08F 220/18; C08G 77/04; C08G 59/02

(52) U.S. Cl. CPC C08G 59/44; C08K 3/36; C08L 63/04; C08G 59/022; C08K 5/17; C08F 220/1804; C08G 77/045; C08K 5/07

(57) ABSTRACT

A hot melt epoxy resin system includes an epoxy resin composition and a curing agent/catalyst paste composition that is fast curable, isothermal press curable, hot demoldable capable under three minutes at 150° C. and Class A surface giving and suitable to use in the production of automotive interior composite parts, wherein the epoxy resin composition includes an epoxy resin mixture including a first resin and a second resin; at least one thermoplastic toughener; at least one UV hindered amine light stabilizer; at least one UV absorber and/or blocker; 1,3,5-tris(4-tert.-butyl-3-hydroxy-2,6-dimethylbenzyl)-1,3,5-triazine-2,4,6-(1H,3H,5H)-trione as anti-oxidant; hydrophobic fumed silica as air release/rheology agent and hexamethyldisiloxane as an internal mold release agent and the curing agent/catalyst paste composition comprises a paste mixture, which is comprising dicyandiamide (DICY) below a 10 μm particle size and sebacic dihydrazide below a 10 μm particle size.

### CROSS-REFERENCE TO THE RELATED APPLICATIONS

This application is the national stage entry of International Application No. PCT/TR2018/050808, filed on Dec. 14, 2018, which is based upon and claims priority to Turkish Patent Application No. 2017/22994, filed on Dec. 29, 2017, the entire contents of which are incorporated herein by reference.

### TECHNICAL FIELD

Present invention is related with a hot melt epoxy resin system that is fast curable, isothermal press curable, hot demoldable capable under three minutes at 150° C. and Class A surface giving and suitable to use in the production of automotive interior composite parts and a process for making the same.

### BACKGROUND

Use of composite materials in industrial applications such as automotive aerospace and marine applications, have increased in the recent years, thanks to their higher mechanical strength values compared to metals at the same weight. Mechanical strength over the density of materials is called specific strength. The specific strength of material is important especially for parts of automotive, airplane, marine and defence industry. However, composite materials often suffer from their rough and pinhole having surface properties; therefore, they could not fulfill the expectation. Thus, to meet requirements, “Class A” surface finish is needed. In automotive design, a Class A surface is any of a set of freeform surfaces of high efficiency and quality. Class A surface is a vague term used to define surface quality of paints, coating and composites, etc. Class A surfaces do not have any surface defects such as pinholes, craters, orange peel, etc. A surface can be regarded as Class A whether it is matte or shiny butt often surfaces with gloss values higher than 90 are called Class A surfaces. Surface roughness can be a very important parameter for some Class A surfaces. Environmental (light, humidity, chemicals and heat), real life usage conditions and curing/post curing conditions resistance is expected for Class A surfaces with ΔE colour changes less than 2 at predetermined test lengths.

Epoxy term is used for both epoxide functional group and also resins that include the functional group. Epoxy resins may give homopolymerization reaction under acidic and basic catalysis conditions or polyfunctional epoxies may react with polyfunctional primary, secondary amines, special amides, di-hydrazides, diurons, poly carboxylic acids, carboxylic acid anhydrides, di or poly functional phenols and thiols to give cross-linked polymers. These co-reactants often called curing agents, faster co-reactants that give exothermic reaction and catalysing the crosslinking reaction of other groups are called as catalyst/accelerator. Epoxy resin thermoset polymers have higher mechanical properties, temperature and chemical resistance than unsaturated polyester and vinyl ester thermosets. Epoxy resins are often used in formulations of paints, coatings, fiber sizing, glass/carbon/aramid/basalt/natural fibre reinforced composites and adhesives. Epoxy resins are classified by their Tg (glass transition temperature) in Automotive industry Tg<120° C. is called as low Tg, 120° C.<Tg<180 mid Tg and Tg>180° C. High Tg. Hot demoldable prepreg materials have higher Tg than 170-180° C. and thermally stable enough to withstand hot gluing, hot painting and cataphoresis conditions.

One of the preferable techniques for the production of prepreg composite materials for many automotive composite parts is isothermal fast press curing. Prepreg have one of the highest fiber to resin value which further increases the specific strength. Prepreg materials and composite parts produced with prepreg material for the automotive industry composite or other parts require having Class A surface and composite part production times near or equal to the takt time of the final product. Takt time is the average time between the start of production of one unit and the start of production of the next unit, when these production starts are set to match the rate of customer demand. Quick curing for automotive industry is another vague term like Class A yet it is limited with the Takt time in Automotive industry for consumer Cars typical takt time are between 0.5 to 2 minutes. Quick cure demand for automotive industry is curing time that is less than 5 minutes and better to be less than 3 minutes and best to equal to takt times 1-2 minutes. Current level of epoxy resin technology limits the curing time for Class A surface capable hot melt prepregs to not to be curable less than 3 minutes. As cooling and re-heating of the moulds are time consuming processes which makes the composite parts less preferred when the process speed have more importance, it is important to shorten the time consumed in these steps for a shorter takt time. As the importance of process speed increases, isothermal press curing, quick curing and being hot demoldable at cure temperatures become more important factors for composite part production for automotive industry.

Another time consuming process with composite parts for automotive industry is less than class A surfaces which requires additional time consuming surface treatments which usually undesirably results in loss of part details. Moreover, composite parts need special treatment and not capable to treated with usual automotive parts. This makes the composite parts less desirable for general automotive applications. For instance automotive parts are exposed to hot processes like hot gluing and cataphoresis. Traditional prepreg materials in the prior art, which have low Tg<120° C. or Mid Tg 120 to 150° C., are not capable of withstand these conditions. As a result, traditional prepreg materials are not suitable for automotive applications.

In prior art, there are some visual prepreg resin systems for hot melt epoxy prepregging, also for Chemical B staging and solvent containing prepregging. For class A surfaces, parameters of Class A surface giving prepreg resins are defined as certain prepregging/conversion rheology profile, low void content than 2%, wetting of fibre, heat, humidity, chemicals and water resistance. However these systems and methods disclosed in prior art are not completely/adequately defines the required viscosity, surface, cure exotherm, final Tg, curing speed, environmental resistance, heat resistance, UV resistance, tackiness and drapability parameters of Class A surfaces giving fast compression moldable hot melt epoxy prepregs resins, proposed systems have their own disadvantages either in surface quality or process speed or extremely short shelf lives. Automotive parts used in automotive interior composite parts, require curing with OAA technique (preferably press) curable, curing under 3 minutes, hot-demoldable, high Tg suitable for cataphoresis and hot gluing process, class A surface giving, environmental, chemical and UV stable epoxy prepreg resins, methods disclosed either fits less than one or two of the requirements. Hot melt resin prepregging, press molding, Class A surface capabilities requires a very precise viscosity profile for both prepreg production and composite part production. Therefore, there is a need for a precisely defined resin composition and its parameters which will be used as hotmelt epoxy resin prepreg that will be used in the production of automotive interior composite parts.

### SUMMARY

A hot melt epoxy resin system comprising an epoxy resin composition and a curing agent/catalyst paste composition that is fast curable, isothermal press curable, hot demoldable capable under three minutes at 150° C. and Class A surface giving and suitable to use in the production of automotive interior composite parts is provided. Accordingly said resin system comprising the epoxy resin composition comprising an epoxy resin mixture comprising a first resin and a second resin; at least one thermoplastic toughener; at least one UV hindered amine light stabilizer; at least one UV absorber and/or blocker; 1,3,5-tris(4-tert.-butyl-3-hydroxy-2,6-dimethylbenzyl)-1,3,5-triazine-2,4,6-(1H,3H,5H)-trione as anti-oxidant; hydrophobic fumed silica as air release/rheology agent and hexamethyldisiloxane as an internal mold release agent and said curing agent/catalyst paste composition comprising a paste mixture, which is comprising dicyandiamide (DICY) below 10 μm particle size and sebacic dihydrazide below 10 μm particle size; an accelerator selected from the group comprising diurons or imidazoles; cycloaliphatic polyamine as liquid curing agent; fumed silica as air release/rheology agent and silicone diamine as a fiber-matrix adhesion promoter.

A method of producing a hot melt epoxy resin system that is fast curable, isothermal press curable, hot demoldable capable under three minutes at 150° C. and Class A surface giving and suitable to use in the production of automotive interior composite parts comprises the steps of obtaining the epoxy resin composition by adding all individual components of said epoxy resin composition into a first vessel and heating the mixture at 90° C. and for 30 minutes while stirring; obtaining a curing agent/catalyst paste composition by adding all individual components of said curing agent/catalyst paste composition into a second vessel and mixing them with a mixer preferably at 1000 rpm preferably for 15 minutes; heating the obtained epoxy resin composition at 65° C. for 3 hours; adding heated epoxy resin in a container than adding curing agent/catalyst paste composition in same container; mixing them at 60° C. for 6 minutes at 1000 rpm to obtain hot melt epoxy resin system.

Therefore; precisely defined, hot melt epoxy resin system resin system and production method thereof is provided. Thanks to these parameters, resins system is used as hotmelt epoxy resin prepreg that will be used in the production of automotive interior composite parts. Moreover, said epoxy resin system satisfies the quick cure demand

One of the objects of the invention is to provide a hot melt epoxy resin system that satisfies the quick cure demand (curing time is less than 5 minutes and better to be less than 3 minutes and best to equal to takt times 1-2 minutes) of the automotive industry.

One of objects of the invention is using a hot melt prepreg which is optimized for isothermal press curing and hot demolding and production of composite parts with that prepreg isothermal press curing and hot demolding at cure temperature.

Another object of the invention is to provide a hot melt epoxy resin system that is capable of giving Class A composite surface quality with fast press curing.

Another object of the invention is to provide a production method of hot melt epoxy resin system with fast press curing under 3 minutes and yet still capable of giving Class A surfaces.

One other of the objects of the invention is a hot melt epoxy resin system that has High Tg (170° C. and beyond with measuring DSC and DMA Tan δ) and that is sufficient to withstand cataphoresis, hot bonding and hot coating application conditions.

### BRIEF DESCRIPTION OF THE DRAWINGS

FIG. 1; shows a parameter graph for press curing.

FIG. 2; shows a graph of DMA curing method for Example 4.

FIG. 3; shows a graph of DMA Curing test results of Example 4.

### DETAILED DESCRIPTION OF THE EMBODIMENTS

Use of composite materials in industrial applications such as automotive aerospace and marine applications, have increased in the recent years, thanks to their higher mechanical strength values compared to metals at the same weight. For automotive industry quick curing is significant. Quick cure demand for automotive industry is curing time which is less than 5 minutes and better to be less than 3 minutes and best to equal to takt times 1-2 minutes. Current level of epoxy resin technology limits the curing time for Class A surface capable hot melt prepregs to not to be curable less than 3 minutes. Also class A surfaces require additional time consuming surface treatments which usually undesirably results in loss of part details. Moreover, composite parts need special treatment and not capable to treated with usual automotive parts. This makes the composite parts less desirable for general automotive applications. In prior art, there are some visual prepreg resin systems for hot melt epoxy prepregging. However, these systems and methods disclosed in prior art are not completely/adequately defines the required viscosity, surface, cure exotherm, final Tg, curing speed, environmental resistance, heat resistance, UV resistance, tackiness and drapability parameters of Class A surfaces giving fast compression moldable hot melt epoxy prepregs resins, proposed systems have their own disadvantages either in surface quality or process speed or extremely short shelf lives. Therefore, there is a need for a precisely defined resin composition and its parameters which will be used as hotmelt epoxy resin prepreg that will be used in the production of automotive interior composite parts. Therefore, a hot melt epoxy resin system that is fast curable, isothermal press curable, hot demoldable capable under three minutes at 150° C. and Class A surface giving and suitable to use in the production of automotive interior composite parts and processes for making the same are provided by the present invention.

A hot melt epoxy resin system that is fast curable, isothermal press curable, hot demoldable capable under three minutes at 150° C. and Class A surface giving and suitable to use in the production of automotive interior composite parts comprises an epoxy resin composition and a curing agent/catalyst paste composition. Said epoxy resin composition comprises a mixture comprising a first resin and a second resin; at least one thermoplastic toughener (preferably 2.5-5% wt. of total composition); at least one UV hindered amine light stabilizer (preferably 0.70-1.5% wt. of total composition); at least one UV absorber and/or blocker (preferably 2.5-5% wt. of total composition); 1,3,5-tris(4-tert.-butyl-3-hydroxy-2,6-dimethylbenzyl)-1,3,5-triazine-2,4,6-(1H,3H,5H)-trione as an anti-oxidant (preferably 0.1-0.5% wt. of total composition); hydrophobic fumed silica as an air release agent/rheology (preferably 0.1-0.5% wt. of total composition) and hexamethyldisiloxane as an internal mold release agent (preferably 0.25-1.25% wt. of total composition). Said curing agent/catalyst paste composition comprises a paste mixture which is comprising dicyandiamide (DICY) below 10 μm particle size and sebacic dihydrazide below 10 μm particle size; d an accelerator selected from the group comprising diurons or imidazoles (below 10 μm particle size or in liquid form) (preferably functionalized diuron and/or N′-(3,4-Dichlorophenyl)-N,N-dimethylurea). Said curing agent/catalyst paste composition also comprises cycloaliphatic polyamine as liquid curing agent; fumed silica as an air release/rheology agent, and silicone diamine as a fiber-matrix adhesion promoter.

In one embodiment of the invention, the first resin comprises phenolic novalac and/or bisphenol A wherein molecular weight of the first epoxy resin is less than 500 atomic mass unit (AMU). Also, the second resin comprises epoxy phenolic novalac and/or epoxy cresol novalac wherein molecular weight of the first epoxy resin is from 550 to 1700 atomic mass unit (AMU).

In one embodiment of the invention, epoxy resin composition preferably comprises 10-30% of the first resin by weight percent based on total weight of the epoxy resin composition. Also, the epoxy resin composition preferably comprises 60-82.5% of the second resin by weight percent based on total weight of the epoxy resin composition.

In one embodiment of the invention, the hot melt epoxy resin system comprises 100 Pbw of epoxy resin composition and 27 Pbw of curing agent/catalyst paste composition. Also, the hot melt epoxy resin system preferably comprises 100 Phr of epoxy resin composition and 29-36 Phr of curing agent/catalyst paste composition.

In an alternative embodiment of the invention, said curing agent/catalyst paste composition comprises 46.00% of the cycloaliphatic polyamine; 0.5% of silicone diamine; 14.00% of dicyandiamide below 10 μm particle size; 23.00% of sebacic dihydrazide below 10 μm particle size; 10.00% of diurons and 6.50% of Spernat D17 by weight percent based on total weight of the curing agent/catalyst paste composition.

In an embodiment of the invention, the second resin preferably have the EEW value between 215-220 g/eq more preferably better 175-188 g/eq for fast curing. Average mw of 1200 to 1700 or better to 550 to 700 atomic mass unit.

In an embodiment of the invention low molecular weight epoxy phenolic novalac, bisphenol A epoxy, the first resin preferably have the EEW value between 215-220 g/eq more preferably better 175-188 g/eq for fast curing. Average molecular weight is less than 500 atomic mass unit.

In one embodiment of the invention, for fast curing agent/catalyst paste composition described in this invention the AHEW (Amine Hydrogen Equivalent Weight) of cycloaliphatic polyamine is preferably between 50 to 70 g/eq, more preferably better 55 to 65 g/eq to fulfil cure exotherm limits.

In one other embodiment of the invention, said UV absorber and/or blocker is bis (1,2,2,6,6-pentamethyl-piperidyl)sebacate and/or methyl 1,2,2,6,6-pentamethyl-4-piperidyl sebacate. UV hindered amine light stabilizer preferably is 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine, preferred. Epoxy resins tend to yellow and even chemically decompose with UV absorption. UV absorbers and blockers are needed to protect the epoxy resin system and carbon fiber.

In an embodiment of the invention, said anti-oxidant is 1,3,5-tris(4-tert.-butyl-3-hydroxy-2,6-dimethylbenzyl)-1,3,5-triazine-2,4,6-(1H,3H,5H)-trione. Anti-oxidant is used with UV absorber and/or blocker additive for further synergistic effects. Amine groups tend to be yellow by giving reaction with oxygen in air by time and also exposure to hot air during cure conditions. In order to prevent this problem anti-oxidant is used. Moreover, internal mold release agent is preferably CAS Number: 107-46-0, hexamethyldisiloxane. Internal mold release agents are used to facilitate the mold release.

In an embodiment of the invention, said thermoplastic toughener preferably is modified PMMA block-PBA (Poly Butyl Acrylate) block-PMMA block thermoplastic acrylic tougheners (preferably high polarity modified). Thermoplastic toughening agents are preferably used in the invention as they do not affect the transparency of resin. Thermoplastic toughener also improves the mold release behavior, surface quality and increase the viscosity of the resin. Moreover, hydrophobic fumed silica is used as air release/rheology agent. Lowest amount of said agent is 0.5% of the weight of the total epoxy resin composition up to 2% but it is used in order not to effect interlaminar properties which is 0.1% in epoxy resin.

In an embodiment of the invention, epoxy resin composition comprises hydrophobic fumed silica as air release/rheology agent. Said agent is used for hotmelt epoxy resins since resins are expected to have very high viscosities at low temperatures yet very low viscosities at prepreg production temperatures and also molding temperatures.

In the present invention curing agent/catalyst paste composition comprises solid and liquids which are not soluble in each other viscosity is needed to increase in this mixtures so dimethyldichlorosilane Amine Hydrogen Equivalent Weight) is used 0 to 6.5%.

In an embodiment of the invention, said epoxy resin composition preferably comprises liquid silicone diamine. It is used to promote fiber-matrix adhesion, anti-scratch and osmosis resistance. It is also used as internal mold release agent. Said epoxy resin composition comprises less than 1% (wt. of total composition) liquid silicone diamine since the silicone containing additive negatively affect the paintability at higher percentages.

In an alternative embodiment of the invention Chemtrend-Zyvax Chemlease IC25 (propriety chemical) is preferably used as internal mold release additive, BASF Chimasorb 2020 (1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine, CAS: 192268-64-7) and/or BASF Tinuvin 770 DF (CAS: 41556-26-7 EC: 255-437-1 bis (1,2,2,6,6-pentamethyl-piperidyl)sebacate, CAS: 82919-37-7 EC: 280-060-4 methyl 1,2,2,6,6-pentamethyl-4-piperidyl sebacate) are preferably used both as UV hindered amine light stabilizer and UV absorber Sonox 3114 (1,3,5-tris(4-tert.-butyl-3-hydroxy-2,6-dimethylbenzyl)-1,3,5-triazine-2,4,6-(1H,3H,5H)-trione) is preferably used as Anti-Oxidant, Acrylic Arkema Nanostrength M52N (high polarity modified PMMA block-PBA (Poly Butyl Acrylate) block-PMMA block thermoplastic acrylic toughener) is preferably used as toughener, BYK A 530 air release additive, Evonik Degussa Spernat D17 (CAS No: 68611-44-9, Silane, dichlorodimethyl-, reaction products with silica) is used as rheology additive, defoamer and/or anti-caking agent and TEGOMER® A-Si 2322 (liquid silicone diamine) is preferably used as fiber-matrix adhesion promoter, anti-scratch and/or internal mold release agent.

Table 1 is showing an exemplary formulation of epoxy resin composition according to present invention.

TABLE 1

| Type of chemicals | Wt. % min | Wt. % max | EEW g/eq Min | EEW g/eq Max |
|---|---|---|---|---|
| Low Mw Epoxy Phenol Novalac | 10 | 30 | 145 | 195 |
| and/or Bisphenol A | | | | |
| High Mw Epoxy Phenolic Novalac | 82.5 | 60 | 175 | 235 |
| and or Epoxy Cresol Novalac | | | | |
| Thermoplastic Toughener | 2.5 | 5 | — | — |
| UV hindered amine light stabilizer | 0.70 | 1.5 | — | — |
| UV absorber | 2.5 | 5 | — | — |
| anti-oxidant | 0.1 | 0.25 | — | — |
| Air release/rheology agent | 0.1 | 0.5 | — | — |
| Internal Mold release | 0.25 | 1.25 | — | — |
| Air release/rheology additive | 0 | 0.5 | — | — |

In an embodiment of the invention, curing rheology of epoxy resin composition is following. Complex coefficient of viscosity of the epoxy resin composition is preferably η*<0.5-5 poise at t=0 at 150° C. Preferably, complex coefficient of viscosity of the epoxy resin composition is η*>104 poise at t=300 seconds at 150° C. Energy loss of the epoxy resin composition is tan δ<0.1 150° C. after 300 seconds.

In an alternative embodiment of the invention, epoxy resin is a mixture of the first resin and second resin wherein the ratio of the first resin to the second resin 1:3 to 1:9 in order to fulfill rheology profile requirements described press curing conditions, hot melt prepregging, Class A surface this resin composition in invention:

Table 2 shows the ideal viscosity profile for an epoxy resin composition suitable for being used to hot melt epoxy resin that is fast curable, isothermal press curable, hot demoldable.

TABLE 2

| | 20° C. | 40° C. | 50° C. | 65° C. | 75° C. |
|---|---|---|---|---|---|
| Complex | 10⁶ to 2 × 10⁶ | 1000 to | 1000 to | 50 to 500 | 40 to 60 |
| coefficient | | 2 × 10⁴ | 2 × 10⁴ | | |
| of viscosity | | | | | |
| η* (poise) | | | | | |
| Loss | 10⁶ Pa to 10⁷ | — | — | — | — |
| modulus G″ | Pa | | | | |
| (Pa) | | | | | |
| Storage | 0.2 × 10⁶ Pa | — | — | — | — |
| modulus G′ | to 4 × 10⁶ Pa | | | | |
| (Pa) | | | | | |
| For | — | — | 100 to 2000 | — | — |
| moderate | | | | | |
| tackiness | | | | | |
| G′ (Pa) | | | | | |
| Good | — | — | 0.9 ≤ G′/η* | — | — |
| windability | | | (Pa/Pa s) | | |
| and | | | ≤2.0 | | |
| tackiness | | | | | |
| Energy loss | — | — | tan δ >> 5 | — | — |

In an embodiment of the invention, DICY below 10 μm particle size (preferably Alzchem Dyhard 1005) and Sebacic Dihydrazide below 10 μm particle size are used in invention as a curing agent mixture for transparent epoxy matrix, for better UV and weathering resistance. As accelerator diurons (preferably UR 200 or UR500) or imidazoles (preferably EM-I 4, or DYHARD® Fluid AC11) with below 10 μm particle size or in liquid form is used. In said agents are dispersed in liquid curing agent cycloaliphatic polyamine (preferably Aradur® 40). To stabilize the curing agent suspension and to prevent caking fumed silica (preferably 7.5% of the total weight) is used (preferably Evonik Spernat D17). As fiber-matrix adhesion promoter di amino terminated silicones such as TEGOMER® A-Si 2322 are used. Di amino terminated silicones are also used to scratch resistance and internal mold release agent and promote the further stabilization of the mixture.

A method of producing a hot melt epoxy resin system that is fast curable, isothermal press curable, hot demoldable capable under three minutes at 150° C. and Class A surface giving and suitable to use in the production of automotive interior composite parts comprises the steps of
obtaining the epoxy resin composition by adding all individual components of said epoxy resin composition into a first vessel and heating the mixture at 90° C. and for 30 minutes while stirring;
obtaining a curing agent/catalyst paste composition by adding all individual components of said curing agent/catalyst paste composition into a second vessel and mixing them with a mixer preferably at 1000 rpm preferably for 15 minutes;
heating the obtained epoxy resin composition at 65° C. for 3 hours;
adding heated epoxy resin in a container than adding curing agent/catalyst paste composition in same container;
mixing them at 60° C. for 6 minutes at 1000 rpm to obtain hot melt epoxy resin system.

In another embodiment of the method disclosed in the invention, components of epoxy resin composition, such as high mw epoxies, UV additives, anti-oxidant and thermoplastic tougheners which are not liquid or crystalline solid/salt form are melted at their melting temperature for 3 hours before hot melt epoxy resin system preparation.

In another embodiment of the method disclosed in the invention, the step of obtaining the curing agent/catalyst paste composition comprises the step of preparing the curing agent mixture by dispersing curing agent homogeneously into a liquid cycloaliphatic polyamine and difunctional amino silicone; mixing them with a mixer at 1000 rpm for 15 minutes; adding fumed silica to the mixture and mixing them with a mixer at 1000 rpm for preferably 15 minutes to obtain paste curing composition.

### Example 1

Epoxy resin composition of Example 1 is given in the table 4. Preparation of Epoxy Resin composition of example 1 comprises the steps of melting individual components (EPN 1138, Toughener M52N, Cimassorb 2020, Tinuvin 770DF and Antiox SONOX 3114) which are not liquid or crystalline solid/salt form at their melting temperature for 3 hours before epoxy resin preparation, adding all individual components including ones that melted into a dissolution vessel and heating and mixing at 90° C. for 30 minutes to obtain epoxy resin formulation of Example 1. In an alternative embodiment of the invention Chemtrend-Zyvax Chemlease IC25 (propriety chemical) is preferably used as internal mold release additive, BASF Chimasorb 2020 (1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine, CAS: 192268-64-7) and/or BASF Tinuvin 770 DF (CAS: 41556-26-7 EC: 255-437-1 bis (1,2,2,6,6-pentamethyl-piperidyl)sebacate, CAS: 82919-37-7 EC: 280-060-4 methyl 1,2,2,6,6-pentamethyl-4-piperidyl sebacate) are preferably used as UV additive, Sonox 3114 (CAS-Number: 40601-76-1,3,5-tris(4-tert.-butyl-3-hydroxy-2,6-dimethylbenzyl)-1,3,5-triazine-2,4,6-(1H,3H,5H)-trione) is preferably used as Anti-Oxidant, Acrylic Arkema Nanostrength M52N (high polarity modified PMMA block-PBA (Poly Butyl Acrylate) block-PMMA block thermoplastic acrylic toughener) is preferably used as toughener, BYK A 530 air release additive, Evonik Degussa Sipernat D17 (CAS No: 68611-44-9, Silane, dichlorodimethyl-, reaction products with silica) is used as rheology additive, defoamer and/or anti-caking agent and TEGOMER® A-Si 2322 (liquid silicone diamine) is preferably used as fiber-matrix adhesion promoter, anti-scratch and/or internal mold release agent.

TABLE 4

| Resin | | | |
|---|---|---|---|
| composition | Chemical ID | Type of chemicals | Wt. % |
| EPN 1183 | CAS: 28064-14-4 Epoxy Phenol Novalac | Low Mw Epoxy | 21 |
| | | Phenol Novalac | |
| EPN 1138 | CAS: 28064-14-4 Epoxy Phenol Novalac | High Mw Epoxy | 62 |
| | | Phenolic Novalac | |
| Toughener | Acrylic Arkema Nanostrength M52N (high | Thermoplastic | 5 |
| M52N | polarity modified PMMA block-PBA(Poly | Toughener | |
| | Butyl Acrylate)block-PMMA block | | |
| | thermoplastic acrylic toughener | | |
| Chimassorb | 1,6-Hexanediamine, N,N′-bis(2,2,6,6- | UV hindered | 1.5 |
| 2020 | tetramethyl-4-piperidinyl)-polymer with | amine light | |
| | 2,4,6-trichloro-1,3,5-triazine, reaction | stabilizer | |
| | products with N-butyl-1-butanamine and N- | | |
| | butyl-2,2,6,6-tetramethyl-4-piperidinamine, | | |
| | CAS: 192268-64-7 | | |
| Tinuvin 770 | CAS: 41556-26-7 EC: 255-437-1 bis | UV absorber | 7 |
| DF | (1,2,2,6,6-pentamethyl-piperidyl)sebacate, | | |
| | CAS: 82919-37-7 EC: 280-060-4 methyl | | |
| | 1,2,2,6,6-pentamethyl-4-piperidyl sebacate | | |
| Antiox | CAS-Number: 40601-76- 1,3,5-tris(4-tert.- | anti-oxidant | 0.5 |
| SONOX | butyl-3-hydroxy-2,6-dimethylbenzyl)-1,3,5- | | |
| 3114 | triazine-2,4,6-(1H,3H,5H)-trione | | |
| Airrel BYK | CAS No: 68611-44-9, Silane, | Air | 1 |
| A 530 | dichlorodi methyl-, reaction products with | release/rheology | |
| | silica | agent | |
| Intrel IC25 | propriety chemical | Internal Mold | 0.25 |
| | | release | |
| Sipernat D17 | CAS No: 68611-44-9, Silane, | Air | 1.75 |
| | dichlorodimethyl-, reaction products with | release/rheology | |
| | silica | additive | |
| Sum | | | 100 |

Rheometer Parameters:

Parallel plate 2 mm gap and 25 mm plates

Shear Stress (oscillating)

Amplitude tau=3 Pa

Frequency f=1 Hz

T=25-180° C. linear

Rheometer results with above set parameters:

Viscosity at 80° C. is 27 poise

### Example 2

Curing agent/catalyst paste composition of Example 2 is given in the table 5. Preparation of Epoxy Resin composition of example 2 comprises the steps of preparing a curing agent mixture comprising 23% Sebacic Dihydrazide, 14% Dicyandiamide and 10% accelerator by dispersing curing agent homogeneously into a portion of 46% with a liquid cycloaliphatic polyamine and 0.5% difunctional amino silicone and mixing them with a mixer preferably at 1000 rpm for preferably 15 minutes; adding 0.25 to 7.5% (preferably 6.5%) fumed silica viscosity modifier 6.5% to the mixture and mixing them with a mixer preferably at 1000 rpm for preferably 15 minutes to obtain curing agent/catalyst paste composition.

TABLE 5

| Curing agent/catalyst paste | | | |
|---|---|---|---|
| composition | Chemical ID | Type of chemicals | Wt. % |
| Aradur ® 40 | Liquid curing | CAS Number: 6864-37- | 46.00% |
| | agent | 5, 4,4′-Methylenebis(2- | |
| | | methylcyclohexylamine) | |
| TEGOMER ® A-Si 2322 | fiber-matrix | Aminoalkyl functional | 0.5% |
| | adhesion | polydimethylsiloxane | |
| | promoter, anti- | | |
| | scratch and/or | | |
| | internal mold | | |
| | release agent | | |
| Dyhard 100S | Solid curing | CAS: | 14.00% |
| | agent | 461-58-5, | |
| | | Dicyandiamide | |
| Sebacic dihydrazide particle | Solid curing | CAS: 925-83-7, Sebacic | 23.00% |
| size <10 μm | agent | dihydrazide | |
| UR 200 | Accelerator | CAS: 330-54-1, | 10.00% |
| | | Functionalized diuron, | |
| | | N′-(3,4- | |
| | | Dichlorophenyl)-N,N-dimethylurea | |
| Sipernat D17 | Air | (CAS No: 68611-44-9, | 6.50% |
| | release/rheology | Silane, | |
| | additive | dichlorodimethyl-, | |
| | | reaction products with | |
| | | silica) | |
| Sum | | | 100.00% |

### Example 3

Example 3 is a hot melt prepregging resin system comprising epoxy resin composition of Example 1 and curing agent/catalyst paste composition of Example 2. Pvw values are given in the table 6. Said example prepared by heating the epoxy resin composition at 65° C. for 3 hours; adding heated epoxy resin in a container than adding curing agent/catalyst paste composition in the container; mixing them preferably at 60° C. preferably for 6 minutes preferably at 1000 rpm.

TABLE 6

| Resin Component | Pbw |
|---|---|
| Epoxy Example 1 | 100 |
| Curing Agent/Catalyst Example 2 | 27 |

Rheometer Parameters:

Parallel plate 2 mm gap and 25 mm plates

Shear Stress (oscillating)

Amplitude tau=3 Pa

Frequency f=1 Hz

T=25-180° C. linear

Rheometer Results,

50° C. 1330 poise

60° C. 340 poise

70° C. 110 poise

80° C. 60 poise

90° C. 25 poise

Isothermal Rheology
Isothermal curing at the temperature
Experiment lasts 60 seconds or before if the complex viscosity reaches 10⁴ Poise (gel time)

Rheology Cure Cycle
3. 50 C to 160 C with 1.33 C/min speed,
4. 160 C 5 minutes isothermal or before if the complex viscosity reaches 10⁴ Poise (gel time)

Isothermal rheology results of example 3 resin mixture at resin bath temperatures 60 and 70° C., resin impregnation temperatures 70 and 80° C. and various curing temperatures 120, 140, 150° C.

| | Isothermal | | | | | |
|---|---|---|---|---|---|---|
| | Temperature | | | | | |
| | Rheology | | | | | |
| | Studies | | | | | |
| Example 3 | 60° C. | 70° C. | 80° C. | 120° C. | 140° C. | 150° C. |
| Initial | 210 Poise | 68 Poise | 28 Poise | 6 Poise | 4 Poise | 1.2 Poise |
| Viscosity | | | | | | |
| Time at | 18.1 | 14.6 | 11.6 | 3.9 | 3.3 | 3.1 |
| % 20 | minutes | minutes | minutes | minutes | minutes | minutes |
| increase | | | | | | |
| in the | | | | | | |
| viscosity | | | | | | |
| Time at | >60 | >60 | 31.8 | 5.8 | 3.5 | 3.2 |
| doubling | minutes | minutes | minutes | minutes | minutes | minutes |
| the | | | | | | |
| viscosity | | | | | | |
| Time | >60 | >60 | 42.2 | 6.6 | 4.2 | 3.8 |
| at 104 | minutes | minutes | minutes | minutes | minutes | minutes |
| viscosity | | | | | | |

Rheology curing experiment results of example % resin mixture at various times and temperatures to simulate the effect of the resin bath, impregnation and curing steps.

Temperature Ramp Experiment Example 3

| | | | | | Time in |
|---|---|---|---|---|---|
| | | | | | seconds |
| | Viscosity In Poises | | | | time |
| 1/seconds | | 75° C. | | | 150° C. t = |
| 50° C. | 65° C. | 40-60 | 85° C. | 150° C. | 0-η* = 10⁴ |
| 0.9 ≤ G′/η* ≤ 2 | 50 to 500 | (t = 0-30) | 10-25 | η* < 0.5 | Poise |
| 1.2 | 203 | 58 | 18 | 1.2 | 228 |

For filming up to 70° C. it is suitable to apply but at 80° C. the residence time is limited to 10 minutes. Also rheometer curing of example shows that the rheology profile of the resin systems is ideal for two stage hot melt prepregging and Class A surface giving press molding.

Fast curing properties of Example 3 was tested with Rheometer and Hot Plate gel times at recommended curing temperatures, usually cure time is double the gel time at that temperature. Example 3 cures at 150° C. under 3 minutes.

| | | |
|---|---|---|
| Initial Mix Viscosity | at 70° C. [Pas] | 68 |
| Gel Time (Hot Plate) | at 150° C. [sec] | 186 |
| Gel Time (Rheometer) | at 150° C. [sec] | 228 |

Cured Matrix Properties (cured at 80° C. 30 minutes→150° C. 60 minutes) of example 3 were tested.

| | | |
|---|---|---|
| Glass Transition | Ramped from RT to 150° C. (10 C./min) | 163 |
| Temp (Tg | @ 150° C. 5 min | |
| by DSC) [° C.] | Ramped 150 to 210° C. (10 C./min) | |
| | Isothermal press @ 160° C., mold @ RT | 168 |
| | Wait to mold reach 160° C. @ 160° C. 5 min | |
| | Ramped 160 to 210° C. (10 C./min) | |
| | Isothermal press @ 180° C., mold @ RT | 170 |
| | Wait to mold reach 180° C. | |
| | @ 180° C. 5 min | |
| | Ramped 180 to 210° C. (10 C./min) | |
| | @ 210° C. 30 min Postcure | |
| | RT to 210° C., @ 210° C. 5 mins, cool to | 175 |
| | 100° C. | |
| Tg DMA | Onset of E′ | 166 |
| 1 Hz, 3° C./min | Maximum of Tan δ | 181 |
| | Maximum of E″ | 172 |
| Tensile Test | Tensile Strength (MPa) | 61 |
| | Tensile Modulus (MPa) | 3007 |
| | Elongation at maximum (%) | 1.6 |
| Compression Test | Compression Strength (MPa) | 116 |
| | Compression Strain at maximum (%) | 4 |
| Flexural Test | Flexural Strength (MPa) | 120 |
| | Flexural Modulus (MPa) | 3500 |
| | Elongation at maximum (%) | 4 |
| Fracture Properties | Fracture toughness K1C, [MPa √m] | 1.2 |
| Bend Notch Test | Fracture energy G1C , [J/m2] | 370 |

### Example 4

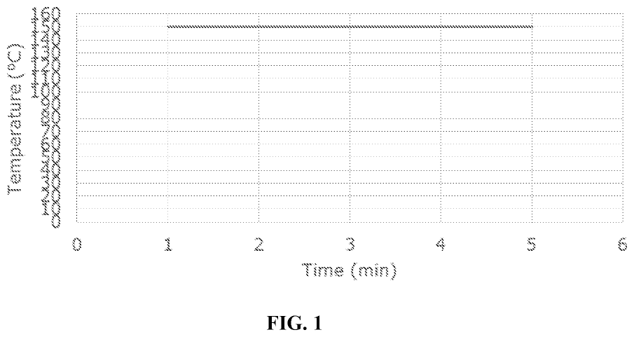

Example 3 is coated on 245 gsm Toray T300 3K Carbon Balanced Fabric as 44% resin on 56% fiber of prepreg. Press curing parameters is applied to Example 4 prepreg for coupon testing and details of the test is given below and parameter graph for press curing is shown in FIG. 1.
Ramp Rate: Consolidated prepregs loaded into a pre-heated tool at 150° C.
Cure Cycle: 5 minutes at 150° C.±5° C., 30 bar platen pressure Cool Down: Cured parts removed from tool without cooling (hot demolding).
Post-Cure Cycle: 6 hours at 150° C.±5° C. at Oven

Press cured composite part properties produced according to press cure cycle 150° C. 7 Bar isothermal with example 4 prepreg:

| | | |
|---|---|---|
| 0° Tensile | Strength (MPa) | 600 |
| | Modulus (GPa) | 67 |
| | Poisson's ratio (Least squares fit) | 0.049 |
| | Poisson's ratio (Chord) | 0.049 |
| 0° Flexural | Strength (MPa) | 800 |
| | Modulus (GPa) | 52 |
| Short Beam (ILSS) | Strength (MPa) | 68 |
| | Modulus (MPa) | 605 |
| In Plane Shear | Strength % 5(MPa) | 80 |
| | Strength Max (MPa) | 120 |
| | Modulus (MPa) | 3200 |
| Tg (° C.) (DMA) | Onset of E′ | 172 |
| | Maximum of Tan δ | 185 |
| | Maximum of E″ | 178 |
| DSC Tg (° C.) | Inflection Point | 173 |

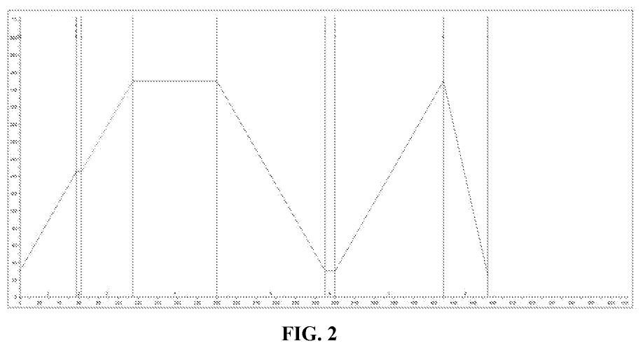

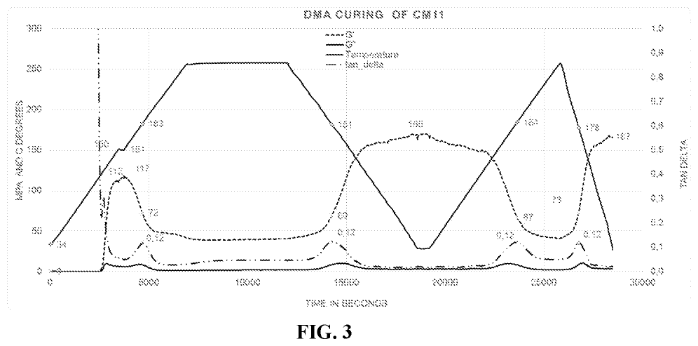

Hot demoldability of Example 4 was tested with DMA. DMA curing studies of uncured prepregs are done for the determination of correct curing parameter with press, checking the curing conditions/time, hot demoldability and also Tg development. DMA curing of prepregs are especially suitable for press curing simulations. Tg development and suitability of TDS suggested curing conditions of Example 4 prepreg is studied with DMA. Also prepreg is subjected to 250° C. for 85 minutes to simulate the effects of cataphoresis to see whether the Tg is reduced or not. During DMA testing Tg value is not effected more than 5° C. so this prepreg is safe to use in cataphoresis, other hot coating and hot gluing applications. DMA curing method graph for Example 4 is given in FIG. 2. Also FIG. 3 is a graph that shows DMA Curing test results of Example 4.

DMA Curing Results Table of Example 4

| | | | | | | | Tan |
|---|---|---|---|---|---|---|---|
| Ts | t | f | F | x | G′ | G″ | delta |
| [−C] | [s] | [Hz] | [N] | [m] | [MPa] | [MPa] | [ ] |
| 182.69 | 4673.00 | 1.00 | 34.99 | 2.48 | 72.33 | 8.36 | 0.12 |
| 181.42 | 14264.00 | 1.00 | 35.01 | 2.58 | 69.10 | 8.45 | 0.12 |
| 184.45 | 23653.00 | 1.00 | 35.02 | 2.66 | 66.94 | 8.08 | 0.12 |
| 177.71 | 26769.00 | 1.00 | 35.00 | 2.46 | 72.76 | 8.59 | 0.12 |

Room temp storage modulus of single layer Example 4 around 165 MPa, After 5 minutes cure at 150 C storage modulus is 116 Mpa at 150 C its 70% of its room temp strength and this prepreg is hot demoldable.

DMA results of example 4:

Tan δ Tg−Tcure=35° C.>15° C.

Tan δ_{diff}=Tan δ_{cooling}−Tan δ_{heating} (182.69−181.42)=1.27° C.<5° C.

Storage modulus at cure temperature after 5 min. isothermal/Storage Modulus at the end of experiment (after cooling at room temp) (116/165)=0.7>0.65

### Example 5

Heat stability test is carried on Example 1 and Example 2 to monitor the stability of various conditions an automotive part is exposed during manufacture processes. Epoxy resins that are used in prepregging is usually exposed to high temperatures at curing 120° C. to 180° C., post curing at 100° C. to 200° C., cataphoresis at 60 to 250° C. and hot gluing at 200 and 300° C. at this temperatures cured prepreg parts should not lose its 5% weight under N₂ and O₂.

TGA weight loss table at 2%, 5%, 10%, 50% and ash content under N2 and O2 of Example 1 and Example 2,

| | Example 1 | | Example 2 | |
|---|---|---|---|---|
| | N2 | O2 | N2 | O2 |
| 2.000% Loss | 25° C. | 250° C. | 150° C. | 150° C. |
| 5.000% Loss | 270° C. | 280° C. | 210° C. | 208° C. |
| 10.00% Loss | 300° C. | 300° C. | 230° C. | 234° C. |
| 50.00% Loss | 420° C. | 470° C. | 300° C. | 295° C. |
| Ash | 14% | 0.1% | 6.7% | 6% |

Sub components of Example 3 resin system are examined with TGA both under O2 and N2, resins systems are stable up to 210° C. (%5 weight losses). This stability ensures that Example 3 resin system is safe to be used at hot processing methods i.e. curing, post curing, hot coating and hot gluing processes whose conditions includes temperatures up to 210° C.

What is claimed is:

1. A hot melt epoxy resin system comprising an epoxy resin composition and a curing agent/catalyst paste composition, wherein the hot melt epoxy resin system is fast curable, isothermal press curable, hot demoldable capable under three minutes at 150° C. and Class A surface giving and suitable to use in a production of a plurality of automotive interior composite parts; wherein
the epoxy resin composition comprising an epoxy resin mixture comprising a first resin and a second resin; at least one thermoplastic toughener; at least one UV hindered amine light stabilizer; at least one UV absorber and/or blocker; 1,3,5-tris(4-tert.-butyl-3-hydroxy-2,6-dimethylbenzyl)-1,3,5-triazine-2,4,6-(1H,3H,5H)-trione as an anti-oxidant; hydrophobic fumed silica as an air release/rheology agent and hexamethyldisiloxane as an internal mold release agent and
the curing agent/catalyst paste composition comprising a paste mixture, wherein the paste mixture comprising dicyandiamide (DICY) below a 10 μm particle size and sebacic dihydrazide below a 10 μm particle size; an accelerator selected from the group comprising diurons or imidazoles; cycloaliphatic polyamine as liquid curing agent; fumed silica as the air release/rheology agent and silicone diamine as a fiber-matrix adhesion promoter.

2. The hot melt epoxy resin system according to claim 1, wherein the first resin comprises phenolic novalac and/or bisphenol A wherein a molecular weight of a first epoxy resin is less than 500 atomic mass unit.

3. The hot melt epoxy resin system according to claim 1, wherein the second resin comprises epoxy phenolic novalac and/or epoxy cresol novalac wherein a molecular weight of a first epoxy resin is from 550 to 1700 atomic mass unit.

4. The hot melt epoxy resin system according to claim 1, wherein the hot melt epoxy resin system comprising 10-30% of the first resin by weight percent based on a total weight of the epoxy resin composition.

5. The hot melt epoxy resin system according to claim 1, wherein the hot melt epoxy resin system comprising 60-82.5% of the second resin by weight percent based on a total weight of the epoxy resin composition.

6. The hot melt epoxy resin system according to claim 1, wherein the hot melt epoxy resin system comprising 2.5-5% of the at least one thermoplastic toughener by weight percent based on a total weight of the epoxy resin composition.

7. The hot melt epoxy resin system according to claim 1, wherein the hot melt epoxy resin system comprising 0.7-1.5% of the at least one UV hindered amine light stabilizer by weight percent based on a total weight of the epoxy resin composition.

8. The hot melt epoxy resin system according to claim 1, wherein the hot melt epoxy resin system comprising 2.5-5% of the at least one UV absorber and/or blocker by weight percent based on a total weight of the epoxy resin composition.

9. The hot melt epoxy resin system according to claim 1, wherein the hot melt epoxy resin system comprising 0.1-0.5% of the anti-oxidant by weight percent based on a total weight of the epoxy resin composition.

10. The hot melt epoxy resin system according to claim 1, wherein the hot melt epoxy resin system comprising 0.1-0.5% of the air release/rheology agent by weight percent based on a total weight of the epoxy resin composition.

11. The hot melt epoxy resin system according to claim 1, wherein the hot melt epoxy resin system comprising an 0.25-1.25% of the internal mold release agent by weight percent based on a total weight of the epoxy resin composition.

12. The hot melt epoxy resin system according to claim 1, wherein a particle size of the accelerator is below 10 μm particle size.

13. The hot melt epoxy resin system according to claim 1, wherein the accelerator is in a liquid form.

14. The hot melt epoxy resin system according to claim 1, wherein the second resin have an EEW value between 215-220 g/eq.

15. The hot melt epoxy resin system according to claim 14, wherein the second resin have an EEW value between 175-188 g/eq.

16. The hot melt epoxy resin system according to claim 1, wherein the first resin have an EEW value between 215-220 g/eq

17. The hot melt epoxy resin system according to claim 16, wherein the first resin have an EEW value between 175-188 g/eq.

18. The hot melt epoxy resin system according to claim 1, wherein the hot melt epoxy resin system comprising 100 Pbw of the epoxy resin composition and 27 Pbw of the curing agent/catalyst paste composition.

19. The hot melt epoxy resin system according to claim 1, wherein the hot melt epoxy resin system comprising 100 Phr of the epoxy resin composition and 29-36 Phr of the curing agent/catalyst paste composition.

20. The hot melt epoxy resin system according to claim 1, wherein the curing agent/catalyst paste composition comprises 46.00% of cycloaliphatic polyamine by weight of a total weight of the curing agent/catalyst paste composition.

21. The hot melt epoxy resin system according to claim 1, wherein the curing agent/catalyst paste composition comprises 0.5% of silicone diamine by weight of a total weight of the curing agent/catalyst paste composition.

22. The hot melt epoxy resin system according to claim 1, wherein the paste mixture comprises 14.00% of dicyandiamide and 23.00% of sebacic dihydrazide by weight of a total weight of the curing agent/catalyst paste composition.

23. The hot melt epoxy resin system according to claim 1, wherein the curing agent/catalyst paste composition comprises 10.00% of the accelerator by weight of a total weight of the curing agent/catalyst paste composition.

24. The hot melt epoxy resin system according to claim 1, wherein the curing agent/catalyst paste composition comprises 6.50% of the air release/rheology agent additive by weight of a total weight of the curing agent/catalyst paste composition.

25. The hot melt epoxy resin system according to claim 1, wherein the UV absorber and/or blocker is bis (1,2,2,6,6-pentamethyl-piperidyl) sebacate and/or methyl1,2,2,6,6-pentamethyl-4-piperidyl sebacate.

26. The hot melt epoxy resin system according to claim 1, wherein the at least one thermoplastic toughener is modified PMMA block-PBA (Poly Butyl Acrylate) block-PMMA block thermoplastic acrylic tougheners.

27. The hot melt epoxy resin system according to claim 1, wherein the at least one UV hindered amine light stabilizer is 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine.

28. The hot melt epoxy resin system according to claim 1, wherein a complex coefficient of a viscosity of the epoxy resin composition is η*<0.5-5 poise at t=0 at 150° C.

29. The hot melt epoxy resin system according to claim 1, wherein a complex coefficient of a viscosity of the epoxy resin composition is η*>104 poise at t=300 seconds at 150° C.

30. The hot melt epoxy resin system according to claim 1, wherein an energy loss of the epoxy resin composition is tan δ<0.1 150° C. after 300 seconds.

31. The hot melt epoxy resin system according to claim 1, wherein a ratio of the first resin to the second resin is 1:3 to 1:9.

32. A method of producing a hot melt epoxy resin system, wherein the hot melt epoxy resin system is fast curable, isothermal press curable, hot demoldable capable under three minutes at 150° C. and Class A surface giving and suitable to use in a production of a plurality of automotive interior composite parts comprising the steps of:
obtaining an epoxy resin composition by adding all individual components of the epoxy resin composition into a first vessel and heating a mixture at 90° C. and for 30 minutes while stirring;
obtaining a curing agent/catalyst paste composition by adding all individual components of the curing agent/catalyst paste composition into a second vessel and mixing all individual components of the curing agent/catalyst paste composition with a mixer at 1000 rpm for 15 minutes;
heating an obtained epoxy resin composition at 65° C. for 3 hours;
adding a heated epoxy resin composition in a container then adding the curing agent/catalyst paste composition in a same container; and
mixing the heated epoxy resin composition and the curing agent/catalyst paste composition at 60° C. for 6 minutes at 1000 rpm to obtain the hot melt epoxy resin system.

33. The method according to claim 32, wherein the step of obtaining the curing agent/catalyst paste composition comprises the steps of:
preparing a curing agent mixture by dispersing the curing agent homogeneously into a liquid cycloaliphatic polyamine and difunctional amino silicone;
mixing the curing agent mixture, liquid cycloaliphatic polyamine and difunctional amino silicone with the mixer at 1000 rpm for 15 minutes; and
adding fumed silica to a mixture and mixing the mixture and fumed silica with the mixer at 1000 rpm for 15 minutes to obtain a paste curing composition.
